(19) United States
(12) Patent Application Publication
(10) Pub. No.: US 2017/0316069 A1
(43) Pub. Date: Nov. 2, 2017

(54) METHOD OF BINDING DATA AND PROCESSES WITH THE USE OF UNIVERSAL COMPUTING ELEMENTS

(71) Applicant: Middleware, Inc., Redwood City, CA (US)

(72) Inventor: OLEKSANDR VITYAZ, Dnipropetrovsk (UA)

(21) Appl. No.: 15/268,802

(22) Filed: Sep. 19, 2016

Related U.S. Application Data
(60) Provisional application No. 62/221,124, filed on Sep. 21, 2015.

(51) Int. Cl. G06F 17/30

(52) U.S. Cl. CPC G06F 17/30569; G06F 17/30377

(57) ABSTRACT

Data processing flow is provided as a set of system states significant for the process. Data and processes are bound using universal computing elements, and thus provided as finite-state automata with explicit selection of states in real-time operation, thereby facilitating construction of finite-state automata (i.e., processes) to users who are not programmers. Advantageously, data processing is organized to reduce impact of inefficient conventional data usage, particularly via data transfer processed innovatively into state format and usage of automata-based programming for data processing.

### CROSS-REFERENCE TO RELATED APPLICATION

This application claims priority to U.S. Application No. 62/221,124 for “Method of Binding Data and Processes with the Use of Universal Computing Elements”, filed on Sep. 21, 2015, which is incorporated herein by reference.

### FIELD OF INVENTION

The invention pertains generally to the field of digital communications, and more particularly to electronic dialog via a telecommunications network whereby data and processes are bound using universal computing elements.

### BACKGROUND OF INVENTION

Conventional electronic databases provide limited functionality, especially as advanced network access to data increasingly requires higher speed storage and access, as well as more complex data formats. For example, there is increasing need for providing higher intensity of data flow, instant availability of data storage, support of incompatible data formats, as well as various changes in data processing. Due to growing complexity of data processing, data processing becomes more time-consuming, thus complicating the process of making changes thereto, and requires higher professional skills of developers to build and modify more complex data systems that more flexibly allow organized online interaction between large number of various system applications.

### SUMMARY

The invention automates data processing flow as a set of system states, particularly whereby data and processes are bound using universal computing elements, as finite-state automata with explicit selection of states in real-time operation, thus facilitating construction of finite-state automata/processes to users. For example, data flow is processed as a set of system states significant for a given process purpose. Preferably for such purpose, data and processes are provided as finite-state automata automatically with explicit selection of states in real-time operation, thereby enabling automata-based construction of finite-state automata or processes, for example, for users who are not programmers. Advantageously, data processing is organized to reduce impact of inefficient conventional data usage, particularly via data transfer processed innovatively into state format and usage of automata-based programming for data processing.

### BRIEF DESCRIPTION OF FIGURES

FIG. 1 illustrates Universal Computing Element (UCE or COREZOID) structure schematically, according to one or more aspect of the present invention.

FIG. 2 illustrates process assembly of Universal Computing Element (UCE or COREZOID) schematically showing steps to transform data into information about states using system assembled with UCE/COREZOID, according to one or more aspect of the present invention.

FIG. 3 illustrates binding data structures and information about states schematically, according to one or more aspect of the present invention.

FIG. 4 illustrates invoice-payment algorithm of one method flow chart automated steps of solving task set in example by creating finite-state automaton with two states, according to one or more aspect of the present invention.

FIGS. 5a-5c illustrate invoice payment process diagram schematically with layout of the Universal Computing Element system automated steps, which allow solving the task set in the example by creating the finite-state automaton with two states according to the algorithm stated above, according to one or more aspect of the present invention.

FIG. 6 illustrates invoice payment process algorithm flow chart of one method of automated steps solving the task set in the example by creating the finite-state automaton with three states, according to one or more aspect of the present invention.

FIGS. 7a-7d illustrate schematically method flow chart layout of Universal Computing Element system automated steps, which allows solving the task set in the example by creating the finite-state automaton with three states according to the algorithm stated above, according to one or more aspect of the present invention.

### DETAILED DESCRIPTION

The invention automates data processing flow as a set of system states, particularly whereby data and processes are bound using universal computing elements, as finite-state automata with explicit selection of states in real-time operation, thus facilitating construction of finite-state automata/processes to users. For example, data flow is processed as a set of system states significant for a given process purpose. Preferably for such purpose, data and processes are provided as finite-state automata automatically with explicit selection of states in real-time operation, thereby enabling automata-based construction of finite-state automata or processes, for example, for users who are not programmers.

Generally it is contemplated herein that computer-automated software method and/or hardware system binds and constructs data and process electronically using universal computing element, whereby data and process associated with a first data processing flow are bound electronically, wherein such data and process are bound using one universal computing element(s) corresponding to system state(s) significant to the data processing flow. Finite-state automata or process may be constructed automatically to facilitate real-time operation of the data processing flow according to such universal computing element(s) via explicit selection of such system state(s). Advantageously, data processing is organized to reduce impact of inefficient conventional data usage, particularly via data transfer processed innovatively into state format and usage of automata-based programming for data processing.

In accordance with one embodiment of the present invention, data is processed per following automated steps:
(1) company data (both found in databases and formed in the course of the company activity without storing as the records in databases) is transformed automatically into finite set of states with the use of the Universal Computing Element (UCE);
   Alternatively in one embodiment, one or more list of states that is significant for data processing may initially be determined analytically, such that company data may then be transformed automatically into finite set of states with the use of UCE. A sample embodiment automates taxi driver processing, using one or more driver states to facilitate determining whether to send order to certain driver; although such driver may have various insignificant states (e.g., male/female, married/single, etc.) For instance, significant states comprise that driver: (a) is waiting for an order, (b) is executing the order, and (c) is offline. Preferably, automated analysis initially determines list of significant states, then proceeds automatically to build one or more algorithm. Thus, data may be transformed automatically into finite set of states, e.g., for advanced usage. And determination of list of states significant for data processing may initially be determined either analytically or automatically.
(2) in the course of data processing in one or more Universal Computing Elements, source data is not sent; instead, parameters required for the processes are sent automatically, and whenever necessary confidential information is replaced automatically by its identifiers;
(3) automata-based programming by adding of new Universal Computing Elements (automata) is used automatically for data processing; and
(4) data is exchanged automatically between units “inside” the diagram of the process and between external sources of data, including other units “external” with regard to current process diagram of the units; therefore, flexible and easy integration is provided.

Thus, users are automatically provided processing environment wherein data converted into more convenient form, whereby such environment provides for processing more efficiently in terms of finite-state automata. Preferably, users cannot process data not in the mode of automata, such that data transferred in this environment is automatically converted into the set of finite states always for generating resulting processes. Furthermore, processes running in this environment may generate new states also in such automata mode. Advantageously, data processing system configured automatically according to such automata-based programming environment provides opportunities for flexible expansion, and constructing stable controllable links to integrate with other network computing systems.

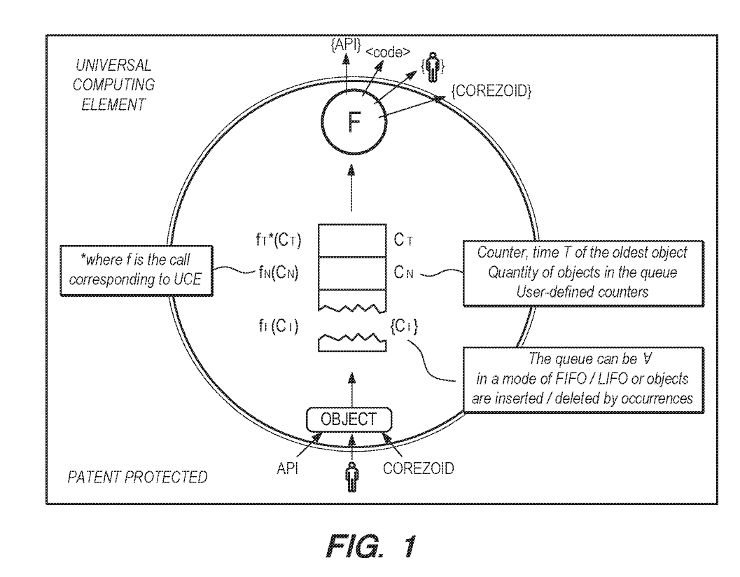

In accordance with one or more aspect of the present invention, one or more Universal Computing Element (UCE or COREZOID) is provided for automatic configuration, as shown schematically in FIG. 1, with one or more of the following structural functions, programmable attributes, or characteristic definitions or nomenclature:

queue—queues of objects in the unit;

semaphores—system and user semaphores; when certain values are reached, semaphore triggers parallel process of escalation;

counters—system and user counters; counter may shows the value only, without action (this is how counters differ from semaphores);

system semaphore T—specified time of the object staying in the unit;

system semaphore N—specified number of objects that can be queued in the unit;

other parameters—which can be specified for objects queued in the unit;

functions—actions to be performed on the object from the queue in the unit; also functions can be in the form of API, software code, other conveyor etc.; when specified values of semaphores and/or functions are violated (exceeded), escalation is triggered (can be arranged with the use of conveyor as well) accepting the objects for processing;

∫—call of relevant function, unit (i);

F—for each unit there is a corresponding function which can be realized through operator, API, code, other unit;

Cm—counter, time T of the oldest object in queue

Cn—number of objects in queue

{Ci}—custom counters

object—set of parameters characterizing the object; according to certain rules, data on the object is processed in the unit—function is applied to the object;

functions—actions to be performed on the object from queue in the unit; functions can be in the form of API, software code, other process etc.;

logic—tools for controlling logic in the unit; system and use logics;

system logic T—specified time of the object staying in the unit;

system logic N—specified number of objects that can be queued in the unit;

For optimization purposes in large systems, counters may be run or accessed on separate servers in a network.

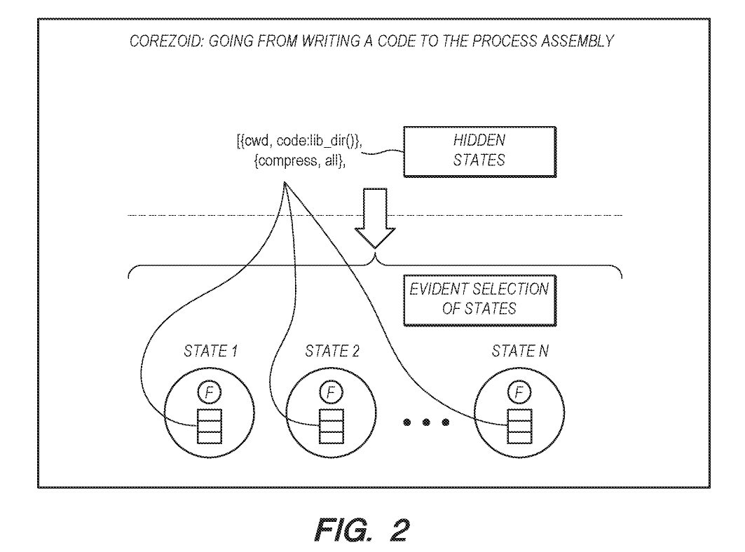

In one embodiment of the present invention, CALLBACK logic is used as basic logic element in the Universal Computing Element. For example, CALLBACK may be used for asynchronous interaction with external API and other processes, such as request when gets to the unit with CALLBACK “hands up” and waits for update from external system of other process. Owing to CALLBACK logic, processes created with the use of the Universal Computing Elements can operate in the mode of finite-state automata, as shown in FIG. 2.

Regarding operation of the Universal Computing Element, generally such unit structurally in hardware, firmware, and/or software embodied using one or more processor, computer, controller, etc., comprises one or more queues, one or more counters, one or more queues, one or more functions from counters (e.g., semaphores), as well as functions applied to queued objects. Initially, information about one or more object may be transferred automatically to the unit queue input (i.e., object identifier—Oi). Such queue may be configured and/or described by standard semaphores and/or counters, e.g., semaphores of time, quantity, etc. Moreover, according to pre-determined or modified rules and/or parameters, data on one or more object is processed in the UCE unit, i.e., the function is applied to such object. Application of function to such object preferably has defined limitations on time and quantity. Also, such functions can be realized through API, code, conveyor, operator, etc. After successful processing of object data, the unit delivers results for further processing to other units, or processing is completed. In case of deviation from normal operation of the unit (e.g., processing time exceeded, more objects in queue which are waiting for processing, etc.), the unit triggers escalation (e.g., escalation algorithm may deploy additional units). Escalation parameters and conditions can be extended based on needs of one or more algorithm.

In particular one embodiment of present invention includes one or more operational method steps for data transformation automatically, as follows:

Step 1. Determination of list of system states significant for data processing;

Step 2. Determination of data parameters used for designation of necessary states;

Step 3. Development of process algorithm for data processing;

Step 4. Designing of Universal Computing Element layout which provides for implementation of the process algorithm;

Step 5. Setting of parameters sent to system and between Universal Computing Elements within the diagram, when units with CALLBACK logic are included into parts of process where system should stop waiting for next event significant for the process. Upon occurrence of one of significant events, system may continue processing of information according to basic diagram to next UCE with CALLBACK logic or final UCE according to the diagram, e.g., go to the next state. If the event significant for the system is expiry of specified waiting time, it is possible to use (i.e., instead of CALLBACK logic) the system semaphore T which turns system to next state upon occurrence of the event, i.e. expiry of specified waiting time.

Step 6. Sending flow of data to be processed to input of diagram assembled of the Universal Computing Elements.

Step 7. Presence of created system of units with CALLBACK logic in the basic diagram leads to mode of data processing, when after each or some significant event, system goes into new significant state and stays in it for a specified time until next significant event occurs.

Step 8. Since each Universal Computing Element may process, obtain and transfer data both to internal and external (i.e., with regard to the process diagram) units, movement of the request (e.g., single set of data about the event in the system) from one unit to another according to the process algorithm and diagram may lead to changing a number of states (e.g., copying, modification, etc.) instead of one state, and initiate new processes built on the same principles.

In one embodiment regarding automated payment of invoices of individuals for services, one or more bank institution based on contracts with service providers (e.g., utility company, telecommunication company, etc.) may receive database on residents' debts for services of such provider company automatically to arrange acceptance of payments from these individuals. Optionally, such provider bank provides individuals opportunity to find out actual amount of their debt and pay invoice issued by the company by any convenient means automatically, e.g., at the bank branch, ATM, through Internet client-bank system, smartphone application, or any other available means. However, conventional invoice payments by individuals are unreliable, for example, since individuals may need to make a request to the database on the amount of bank debt, and initiate payment knowingly; hence, individuals may forget to pay in time or permanently defer their payments altogether, and as a consequence, cash inflow to service provider is reduced significantly. Additionally, customer may routinely contact bank on other transactions, e.g., deposit, transfer receipt, loan servicing, etc., during which customer may pay invoices, i.e., if such customer considers payment then conveniently.

Thus, advantageously according to one or more aspect of the present invention, automated provision of computer-implemented steps facilitates timely receipt of money by service provider, and simplifies procedure of individual invoice payment due to more convenient payment procedure, for example, by eliminating necessity to give a request to the bank of the amount of debt. Preferably, automated invoice for payment of debt waits for customer in any channel of bank service. One automated embodiment of preferred provision of computer-implemented steps follows:

Step 1. Automatically create finite-state automaton with two system states; define the significant states of the system:
(1) Wait for bank customer in whose name invoice is issued at bank point of service, e.g., 30 days, until information on amount of debt is updated;
(2) Display and wait for payment of invoice to pay for services within 10 minutes (i.e., maximum time of contact with customer in bank's service channels).

Step 2. Define various parameters of data:
(1) Information about the service, e.g., type;
(2) Identifier of the individual, e.g., Client_id; and
(3) Amount of invoice for payment, e.g., amount.

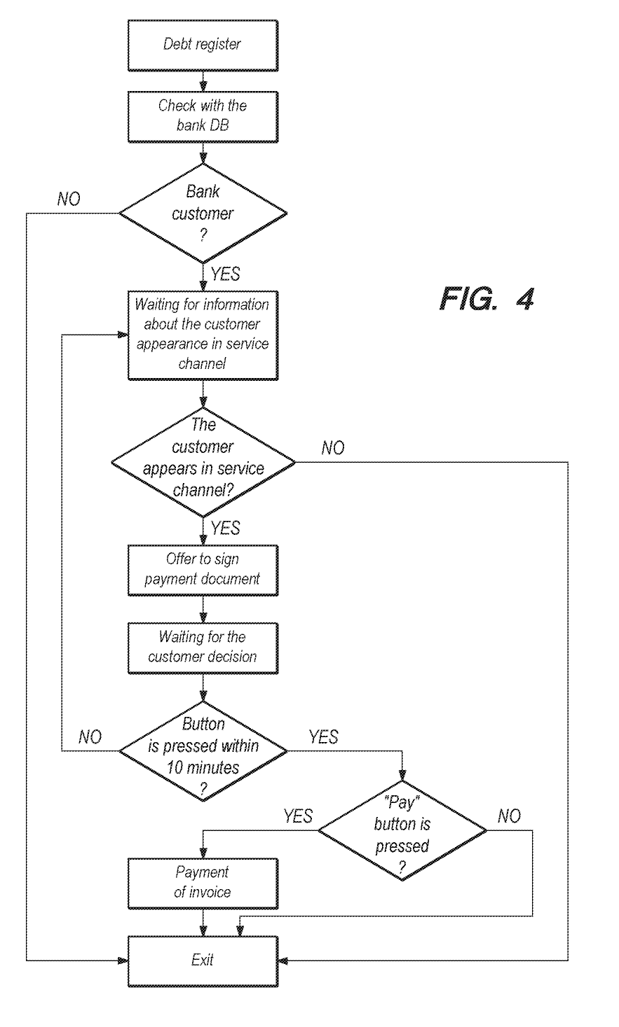

Step 3. Develop the process algorithm for data processing, as shown in FIG. 4

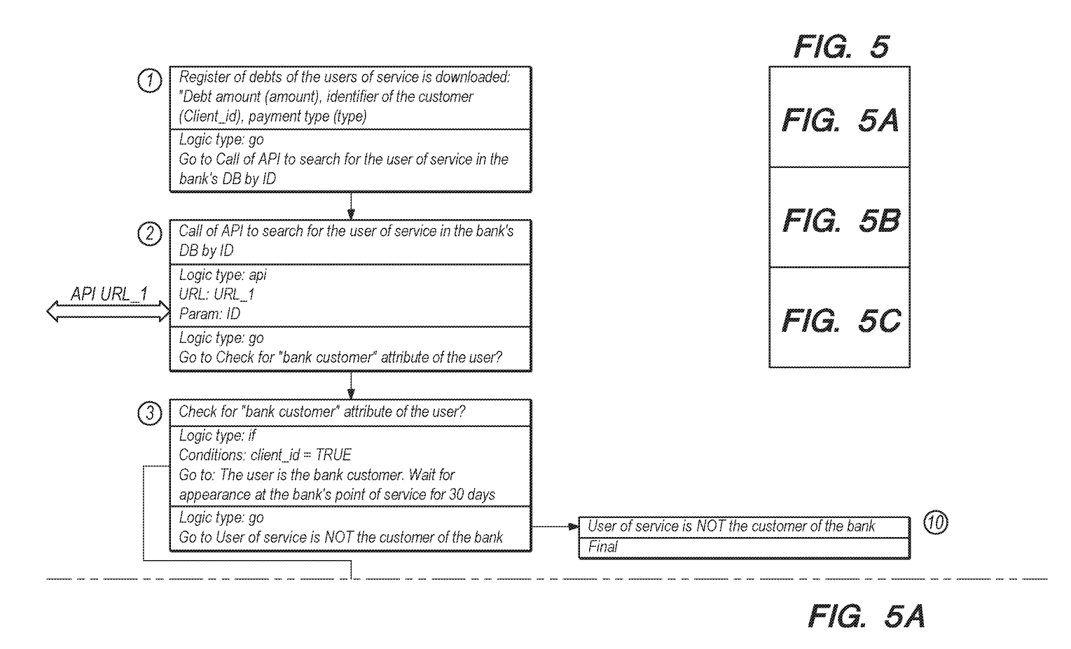

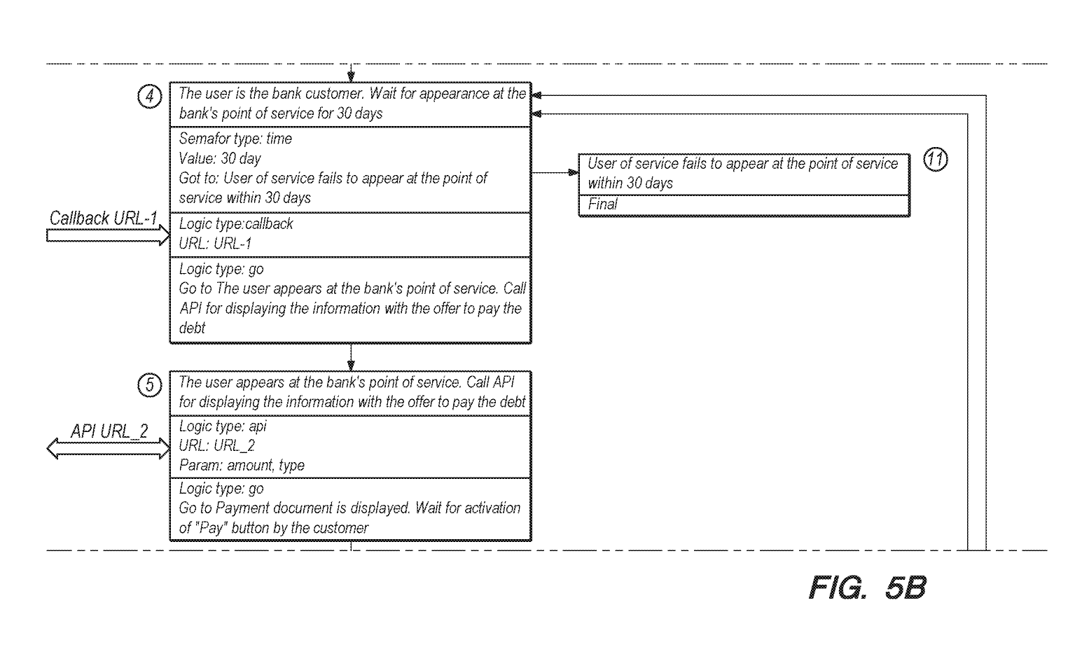

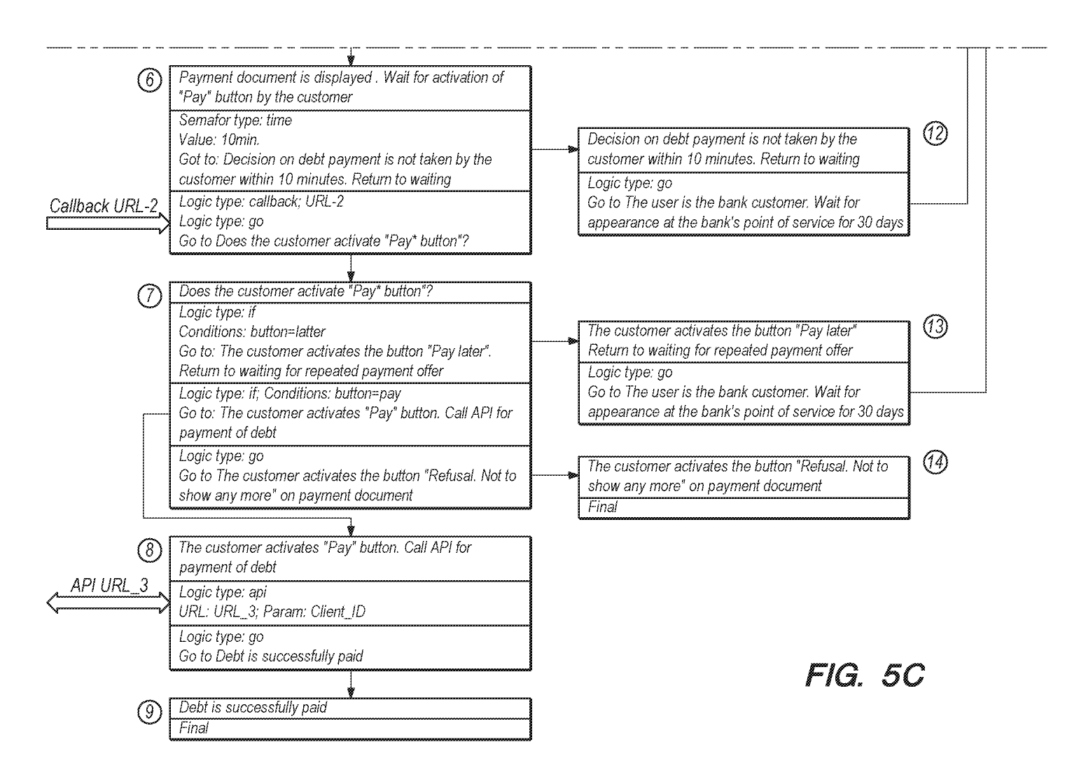

Step 4. Design Universal Computing Element layout, as shown in FIGS. 5a-5c.

By designing UCE unit layout, for example, system configured automatically such that after receiving data of specific request (i.e., information about debt of certain individual) at any time stay in mode of waiting for significant actions of bank customer automatically in one of the following states:
(1) Waiting for bank customer in whose name invoice is issued at bank point of service, e.g., 30 days, until the information on amount of debt is updated; and
(2) Waiting for pressing the “Pay” button by customer in response to bank offer to pay executed payment document, e.g., 10 minutes, maximum time of contact with customer in bank′ service channel.

Optionally, such system configuration is arranged using CALLBACK logic in units 4 and 6 and system semaphore in units 4, 6.

Step 5. Setting parameters sent to the system and between Universal Computing Elements within the diagram. Request in the process shall be set of data described in Step 2.

Step 6. Sending data flow, e.g., table with data on amount of individual invoices sent to system input, as sequence of requests.

Step 7. Passing one or more request through diagram of the process (i.e., automaton units) results in “stopping” of data concerning each transaction in the unit corresponding to current state of the system; upon occurrence of event significant for the process (e.g., appearance of customer in service channel) system automatically goes to next state according to the algorithm and diagram of the process.

In another embodiment, data flow is transformed automatically into the automaton comprising three (i.e., instead of merely two) states, adding opportunity for customer to accept or refuse invoice payment, as follows:

Step 1. Create finite-state automaton with three system states; define significant states of the system automatically, as follows:
(1) Waiting for bank customer in whose name invoice is issued at bank point of service, e.g., 30 days, until information on amount of debt is updated;
(2) Waiting for customer decision in response to bank offer to pay invoice issued to customer, e.g., 10 minutes, average time of customer servicing at bank; and
(3) Waiting for payment of invoice sent to customer after receiving customer consent to pay, e.g., 10 seconds, maximum period of invoice payment in the bank's service channels.

Step 2. Define various parameters of data:

(1) Information about the service, e.g., type;

(2) Identified individual, e.g., Client_id; and

(3) Amount of invoice for services, e.g., amount.

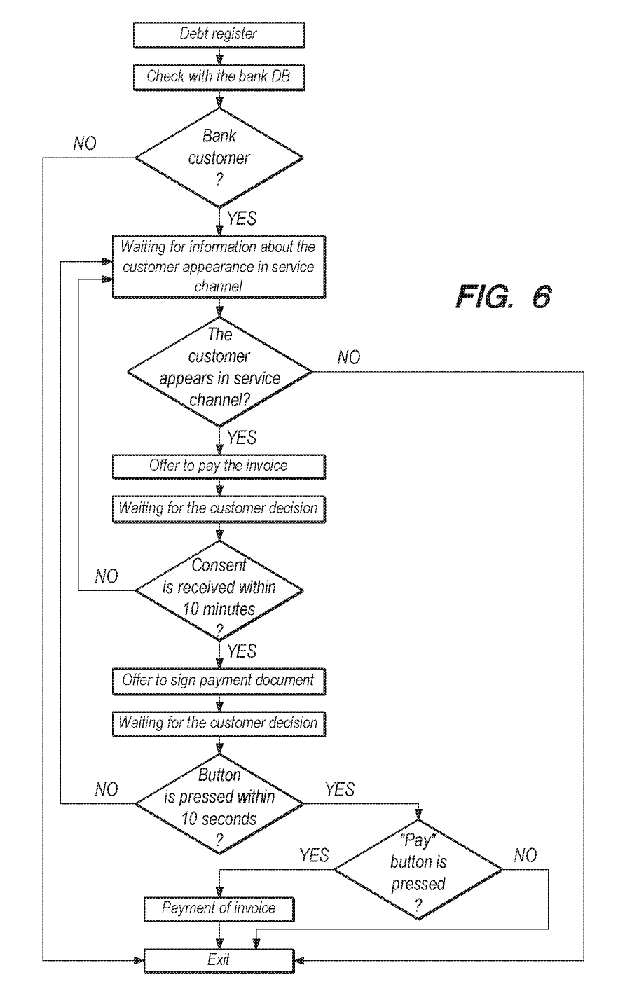

Step 3. Develop the process algorithm for data processing, as shown in FIG. 6.

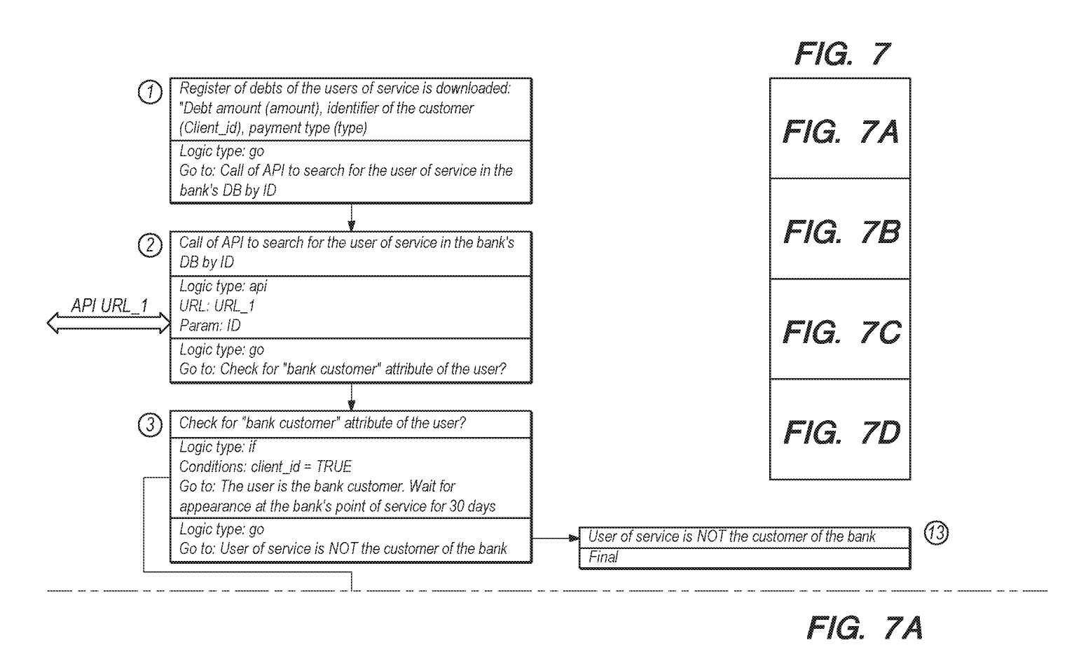

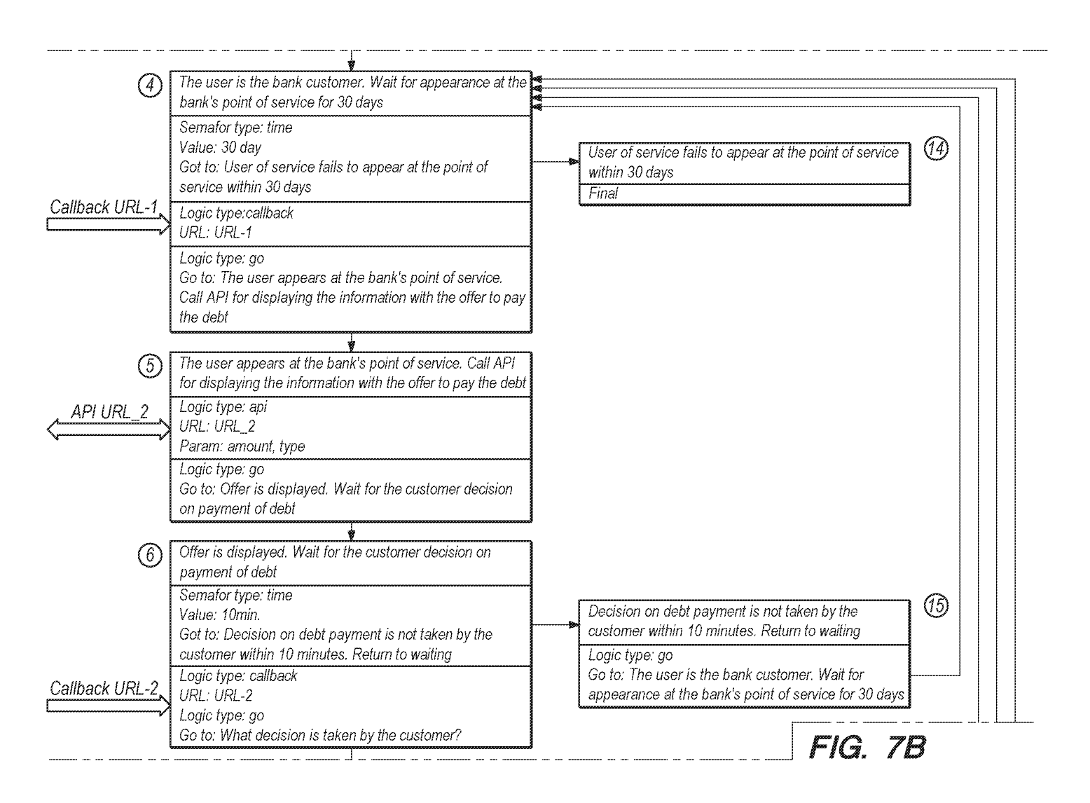

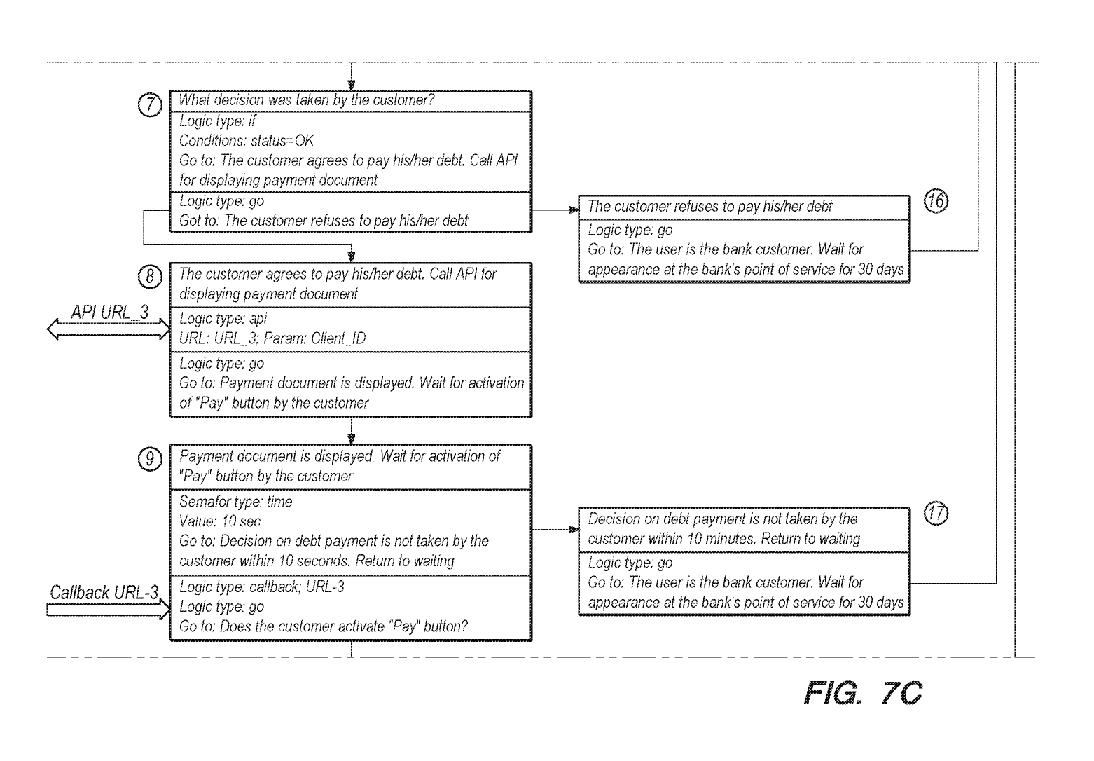

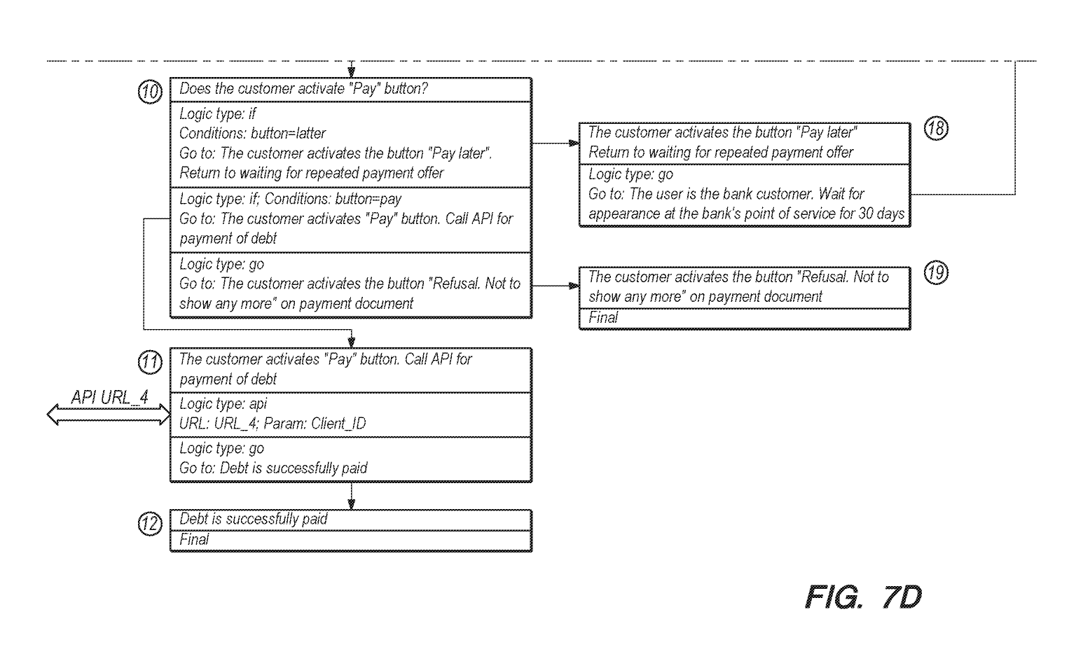

Step 4. Designing layout of Universal Computing Elements, as shown in FIGS. 7a-7d

Regarding UCE unit layout design, it is contemplated herein generally to automate creating a system which after receiving data of request (e.g, information about debt of certain individual) at any time stay in mode of waiting for significant actions, for example, of bank customer in one of the following states:
(1) Waiting for bank customer in whose name the invoice is issued at bank point of service, e.g., 30 days, until information on amount of debt is updated;
(2) Waiting for customer decision in response to bank offer to pay invoice, e.g., 10 minutes; and
(3) Waiting for pressing “Pay” button by customer in response to bank offer to pay executed payment document, e.g., 10 seconds.

Optionally, such system is arranged due to use of CALLBACK logic in units 4, 6 and 9 and system semaphores T in units 4, 6 and 9.

Step 5. Setting of parameters sent to the system and between Universal Computing Elements within the diagram; request in the process may be the set of data described in Step 2.

Step 6. Sending of data flow; table with data on amount of individual invoices is sent to system input, as sequence of requests.

Step 7. Passing of one or more request through the diagram of the process (i.e., automaton units) results in “stopping” of data concerning each transaction in the UCE unit which corresponds to current state of the system; upon occurrence of event significant for the process (e.g., appearance of customer in service channel) the system automatically goes to next state according to the algorithm and diagram of the process.

Generally in accordance with one or more aspects of the present invention, it is contemplated that one or more embodiments automate a computer-implemented system and/or method in accordance with one or more of the following structural and/or programmable limitations, featured functionality, or descriptive notes:
(1) Multi-state automaton examples show various ways of solving system task using Universal Computing Elements, which differ accordingly by parameters of finite-state automaton being created.
(2) During data flow (e.g., list of debtors with indication of amount of debt) to input of the system, one or more automaton is processed automatically in one or more significant states, e.g., waiting for customer, for consent to pay, for payment, etc. (i.e., with regard to indebted customer).
(3) Construction of the system (e.g., automaton with three or two states) is carried out by constructing algorithm for data processing and subsequent implementation of the algorithm in diagram of element binding, comprising Universal Computing Element with one or more functions “active”.
(4) Changing the algorithm of system operation is performed automatically according to change in structure and type of Universal Computing Element functions used.
(5) Interaction of created system with external systems is performed with use of API and/or CallBack functions (logics).
(6) Preferable system may be configured automatically in mode of waiting for information from external systems, and changes state upon receiving relevant data.
(7) Sequence of states hardly coded with the use of the algorithm and diagram automates transforming the data on states into processes which in their turn change state of the system, i.e., “States generate processes, and processes generate states”.
(8) When system stays in mode of waiting for significant event, it results instantly in response of the system (i.e., instant availability of data) to such change.
(9) System constructed in this automated manner allows processing of data not compatible beyond its limits using API logic. Hence present method of data processing may enhance flexibility and complexity of systems considerably owing to possibility of combining and processing data of unlimited number of applications.
(10) The proposed method of system development substantially reduces cost of process of making changes into information systems. Changing the system (e,g. addition/removal of units, logics inclusion to/exclusion from a small set, connection/disconnection of links to external system addresses, etc.) may not require specialized programming skills.

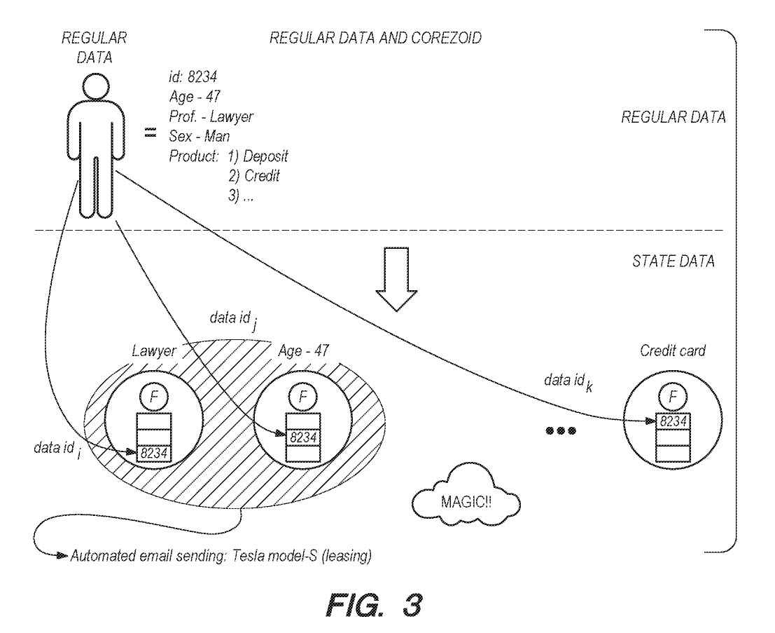

FIG. 1 illustrates Universal Computing Element (UCE or COREZOID) structure schematically. FIG. 2 illustrates process assembly of Universal Computing Element (UCE or COREZOID) schematically showing steps to transform data into information about states using system assembled with UCE/COREZOID. FIG. 3 illustrates binding data structures and information about states schematically. For example, a set of customer historical data is shown to be collected electronically by a bank, and history of customer transactions is transformed automatically onto set of states significant for bank process flow, using data processing system assembled using Universal Computing Elements (UCE/COREZOID). As soon as the process, for which one state or several states are determined to be significant, appears at the bank, the system preferably changes state to next one, according to present process algorithm. FIG. 3 example shows lawyer, a man of 47 years old, having deposit and active credit card; owing to partner program between bank and Tesla car manufacturer, bank automatically makes special offer on buying the car of Tesla model-S on credit to all customers—lawyers at age of 47 years. At the time when the process of the offer sending is initiated, the system automatically determines compliance of the candidate with specified terms and creates new state in the system—“sending of Tesla model-S buying on credit” to the customer ID 8234. Situation when the promotional event started in the past, but the customer reaches the age of 47 years now, gives the same result (i.e., adding of a new state); thus changing “age” state results in change of “Tesla model-S offer” state.

FIG. 4 illustrates invoice-payment algorithm of one method flow chart automated steps of solving task set in example by creating finite-state automaton with two states. FIGS. 5a-5c illustrate invoice payment process diagram schematically with layout of the Universal Computing Element system automated steps, which allow solving the task set in the example by creating the finite-state automaton with two states according to the algorithm stated above. As shown, bidirectional arrows define bidirectional data communication between created system of Universal Computing Elements with external systems by means of API application programs. According to working protocol, one or more parameters contained in request (e.g., type, Client_id, amount) sent from the system, and in response data on results of processing (e.g., customer or not, what button is pressed by the customer in the interface, etc.) is received. Moreover, as shown, unidirectional arrow defines unidirectional data communication between created system of Universal Computing Elements with external systems and/or other processes, assembled of Universal Computing Elements, for example, by using CallBack function. According to protocol of CallBack function, for example, request “hangs up” in Universal Computing Element, and waits for update from external system or other process.

FIG. 6 illustrates invoice payment process algorithm flow chart of one method of automated steps solving the task set in the example by creating the finite-state automaton with three states. FIGS. 7a-7d illustrate schematically method flow chart layout of Universal Computing Element system automated steps, which allows solving the task set in the example by creating the finite-state automaton with three states according to the algorithm stated above.

Foregoing descriptions of specific embodiments of the invention have been presented for purposes of illustration and description. They are not intended to be exhaustive or to limit the invention to the precise forms disclosed. Modifications and variations are possible in light of the above teaching. The embodiments were chosen and described in order to explain the principles and the application of the invention, thereby enabling others skilled in the art to utilize the invention in its various embodiments and modifications according to the particular purpose contemplated. The scope of the invention is intended to be defined by the claims appended hereto and their equivalents.

1. Computer-automated method for binding and constructing data and process electronically using universal computing element, comprising steps:
electronically binding a first data and a first process associated with a first data processing flow, wherein said first data and process are bound electronically using at least one Universal Computing Element (UCE) corresponding to at least one system state that is significant to the first data processing flow; and
automatically constructing at least one finite-state automata or process that enables automated real-time operation of the first data processing flow according to said at least one UCE via explicit selection of said at least one significant system state.

2. The method of claim 1 wherein said construction of at least one finite-state automata or process automatically varies according to different parameters.

3. The method of claim 1 wherein said real-time operation enables one or more transactional wait to correspond automatically with one or more significant state.

4. The method of claim 1 wherein said construction of at least one finite-state automata or process comprises constructing one or more algorithm for data processing and subsequent implementation of such one or more algorithm according to a diagram that structurally binds one or more activated Universal Computing Element.

5. The method of claim 4 wherein construction of said one or more algorithm is changed automatically according to a structural change of one or more Universal Computing Element function.

6. The method of claim 1 wherein said automated real-time operation interacts structurally with one or more external system using an Application Programming Interface (API) and/or CallBack function.

7. The method of claim 1 wherein said automated real-time operation is configured in waiting mode by waiting for external system information and state change according to received data.

8. The method of claim 1 wherein said at least one UCE operates electronically to process at least one algorithm and diagram to transform structurally data regarding one or more state into one or more process, whereby such at least one UCE operates electronically to process said at least algorithm and diagram to transform structurally said one or more process into data regarding one or more state.

9. The method of claim 7 wherein said waiting mode enables instant response to one or more significant event, thereby facilitating instant availability of responsive data.

10. Data processing system comprising:
a processor coupled accessibly to a network, said processor electronically binding a first data and a first process associated with a first data processing flow, wherein said first data and process are bound electronically using at least one Universal Computing Element (UCE) corresponding to at least one system state that is significant to the first data processing flow; said processor automatically constructing at least one finite-state automata or process that enables automated real-time operation of the first data processing flow according to said at least one UCE via explicit selection of said at least one significant system state.

11. The system of claim 10 wherein said construction of at least one finite-state automata or process automatically varies according to different parameters.

12. The system of claim 10 wherein said real-time operation enables one or more transactional wait to correspond automatically with one or more significant state.

13. The system of claim 10 wherein said construction of at least one finite-state automata or process comprises constructing one or more algorithm for data processing and subsequent implementation of such one or more algorithm according to a diagram that structurally binds one or more activated Universal Computing Element.

14. The system of claim 13 wherein construction of said one or more algorithm is changed automatically according to a structural change of one or more Universal Computing Element function.

15. The system of claim 10 wherein said automated real-time operation interacts structurally with one or more external system using an Application Programming Interface (API) and/or CallBack function.

16. The system of claim 10 wherein said automated real-time operation is configured in waiting mode by waiting for external system information and state change according to received data.

17. The method of claim 1 wherein said at least one UCE operates electronically to process at least one algorithm and diagram to transform structurally data regarding one or more state into one or more process, whereby such at least one UCE operates electronically to process said at least algorithm and diagram to transform structurally said one or more process into data regarding one or more state.

18. The system of claim 16 wherein said waiting mode enables instant response to one or more significant event, thereby facilitating instant availability of responsive data.

19. Finite-state structural transformation data processing apparatus comprising:
means for electronically binding a first data and a first process associated with a first data processing flow, wherein said first data and process are bound electronically using at least one Universal Computing Element (UCE) corresponding to at least one system state that is significant to the first data processing flow; and
means for automatically constructing at least one finite-state automata or process that enables automated real-time operation of the first data processing flow according to said at least one UCE via explicit selection of said at least one significant system state.
